(19) United States
(12) Patent Application Publication
(10) Pub. No.: US 2021/0260879 A1
(43) Pub. Date: Aug. 26, 2021

(54) NOZZLE CAMERA SYSTEM AND METHOD FOR INSPECTING THE INSIDES OF PIPES

(71) Applicant: USB-USA, LLC, Douglasville, GA (US)

(72) Inventors: Uli Simpfendorfer, Bretzfeld Schwabbach (DE); Simon Simpfendorfer, Bretzfeld Schwabbach (DE); Martin Hurlebaus, Bretzfeld Schwabbach (DE); Manual Schwab, Bretzfeld Schwabbach (DE); Patrick Savio, Douglasville, GA (US)

(21) Appl. No.: 17/180,142

(22) Filed: Feb. 19, 2021

Related U.S. Application Data
(60) Provisional application No. 62/979,358, filed on Feb. 20, 2020.

(51) Int. Cl. B41J 2/165; G02B 23/24; H04N 5/225

(52) U.S. Cl. CPC B41J 2/16579; H04N 2005/2255; H04N 5/2252; G02B 23/2492

(57) ABSTRACT

A nozzle camera system and method that can be used to inspect the interior of a pipe. The system comprises a nozzle main body, a video camera, a controller and a user interface (UI). The nozzle main body serves as a housing for the video camera and for a jet former configuration. The jet former configuration comprises at least one liquid intake port and at least one liquid flow channel. The liquid intake port has a connection for connecting the jet former configuration to a liquid conduit that supplies liquid to the nozzle main body. The liquid intake port is in fluid communication with the liquid flow channel for supplying liquid via the liquid flow channel to one or more jet ports. The controller is in communication with the video camera and the UI is in communication with the controller and includes at least a display system that displays video images captured by the video camera.

### CROSS-REFERENCE TO RELATED APPLICATIONS

This application is a nonprovisional of and claims priority to U.S. Provisional Application Ser. No. 62/979,358 titled “A NOZZLE CAMERA SYSTEM AND METHOD FOR INSPECTING THE INSIDES OF PIPES”, filed Feb. 20, 2020, which is incorporated herein by reference in its entirety.

### TECHNICAL FIELD

The invention relates to inspection of pipe interiors, such as sewer pipes, for example, and more particularly, to a nozzle camera system and method that can be used to inspect the interior of a pipe.

### BACKGROUND

Sewer pipes transport liquid and solid waste materials from residential, industrial, commercial and other waste producers. Sewer pipes can become clogged from the infiltration of various materials into the interior space of the pipes, such as sand, greasy materials, stones, tree roots, and buildup of other materials that settle out of the waste stream.

Prior to using a root cutter or other tool to clean or clear a pipe, it is often desirable to inspect the interior of the pipe to determine the types and locations of obstructions within the pipe or defects in the pipe itself.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion.

FIG. 1 is a perspective view of a nozzle camera system in accordance with a representative embodiment.

FIG. 2 is a perspective view of a control panel of a user interface (UI) of the nozzle camera system shown in FIG. 1 in accordance with a representative embodiment.

FIG. 3 is a perspective view of a keyboard of the UI of the nozzle camera system shown in FIG. 1 in accordance with a representative embodiment.

FIG. 4 is a perspective view of the nozzle of the nozzle camera system shown in FIG. 1 in accordance with a representative embodiment.

FIG. 5 is a perspective view of the nozzle shown in FIG. 4 mounted on a flexible skid assembly in accordance with a representative embodiment.

FIG. 6 is a perspective view of the nozzle shown in FIG. 4 mounted on a rigid skid assembly in accordance with a representative embodiment.

FIG. 7A is a back-end elevation view of the nozzle shown in FIG. 4 in accordance with a representative embodiment.

FIG. 7B is a top elevation view of the nozzle shown in FIG. 4 in accordance with a representative embodiment.

FIG. 7C is a cross-sectional view of the nozzle shown in FIG. 4 taken along line A-A in FIG. 7B accordance with a representative embodiment.

FIG. 7D is a side elevation view of the nozzle shown in FIG. 4 in accordance with a representative embodiment.

FIG. 7E is a cross-sectional view of the nozzle shown in FIG. 4 taken along line B-B in FIG. 7D in accordance with a representative embodiment.

FIGS. 8A and 8B are the same views as shown in FIGS. 7B and 7C, respectively, but include identifiers for elements of the nozzle in accordance with a representative embodiment to show their locations, such as the video camera, a transparent cover that is within the field of view (FOV) of the camera and a cable channel through which the end of the electrical cable is inserted into the main body of the nozzle for electrically coupling the controller of the system with the camera.

FIG. 9 is a perspective view of the nozzle mounted on a flexible skid assembly and having a lighting adapter secured thereto that has four bright Led lamps mounted in it.

### DETAILED DESCRIPTION

The present disclosure discloses a nozzle camera system and method that can be used to inspect the interior of a pipe for obstructions within the pipe and/or defects in the pipe itself. The system comprises a nozzle main body, a video camera, a controller and a user interface (UI). The nozzle main body serves as a housing for the video camera and for a jet former configuration. The jet former configuration can comprise at least one liquid intake port and at least one liquid flow channel. The liquid intake port has a connection for connecting the jet former configuration to a liquid conduit that supplies liquid to the nozzle main body. The liquid intake port is in fluid communication with the liquid flow channel. The controller is in communication with the video camera and the UI is in communication with the controller and includes at least a display system that displays video images captured by the video camera.

In the following detailed description, a few illustrative, or representative, embodiments are described to demonstrate the inventive principles and concepts. For purposes of explanation and not limitation, representative embodiments disclosing specific details are set forth in order to provide a thorough understanding of an embodiment according to the present disclosure. However, it will be apparent to one having ordinary skill in the art having the benefit of the present disclosure that other embodiments that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

The terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “controller,” as that term is used herein encompasses an electronic component that is able to execute a computer program or executable computer instructions. References herein to a computer comprising “a controller” should be interpreted as a computer having one or more controllers. The controller may, for instance, be a microprocessor or microcontroller. A controller may also refer to a collection of controllers within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

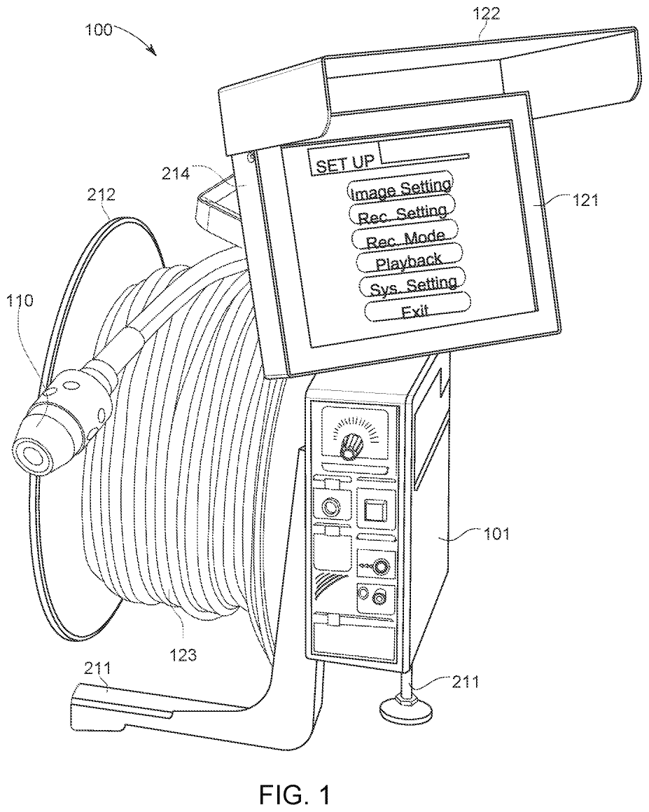

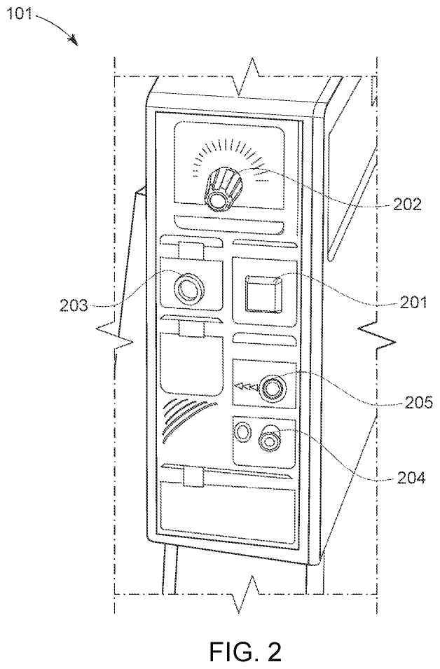

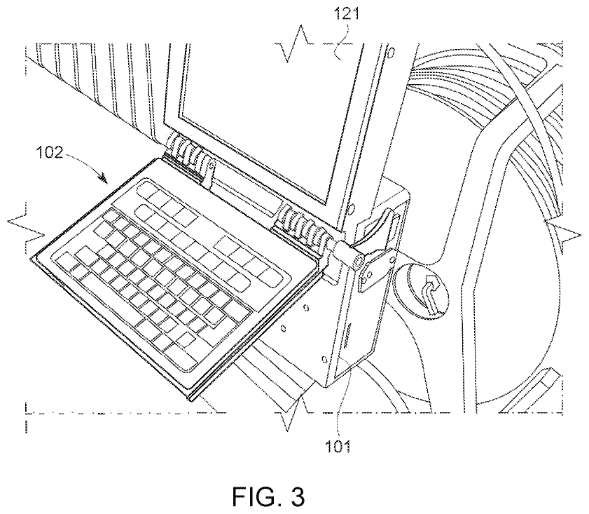

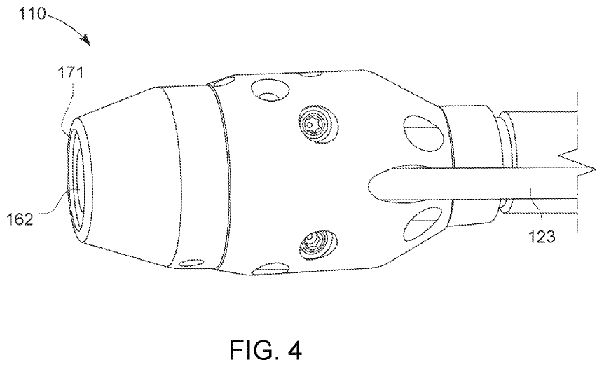

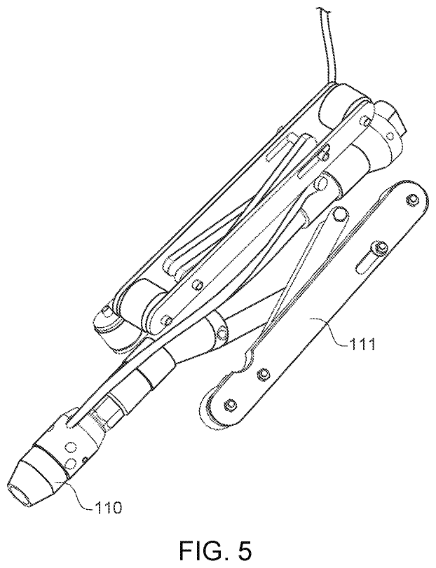

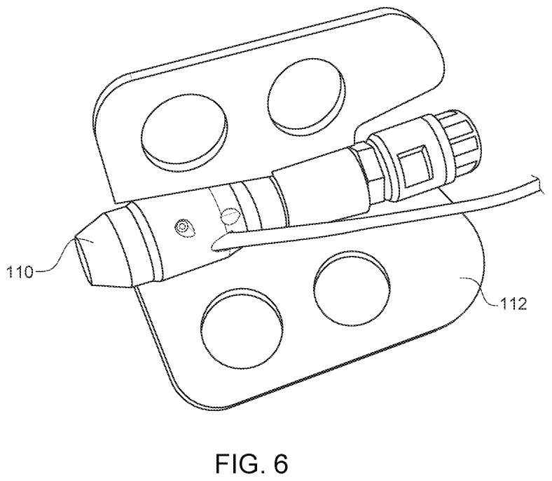

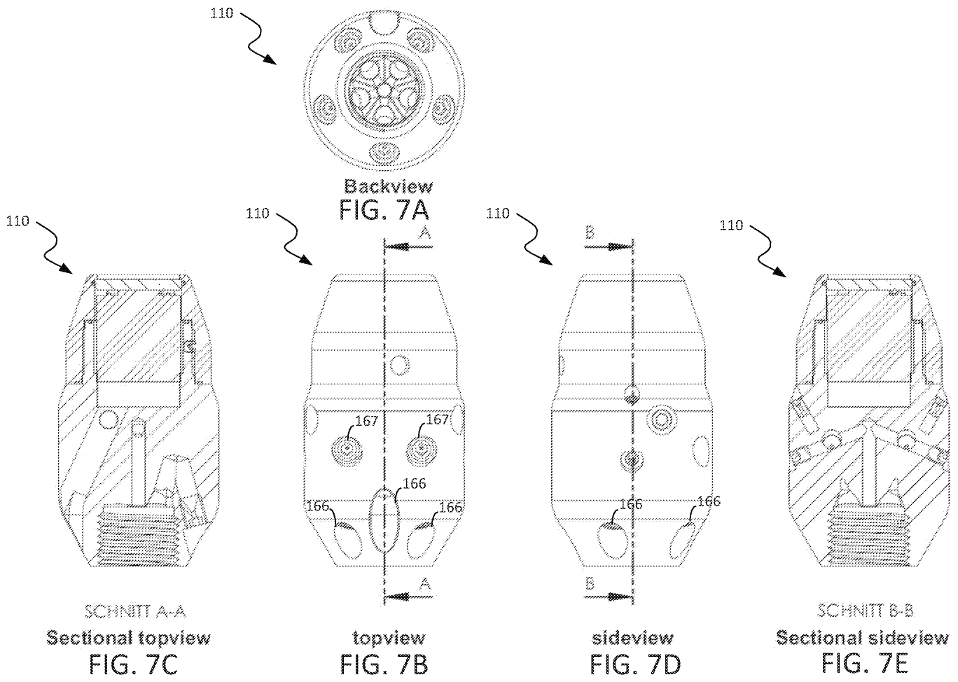

FIG. 1 is a perspective view of the nozzle camera system 100 in accordance with a representative embodiment. FIG. 2 is a perspective view of a control panel 101 of the UI of the nozzle camera system 100 shown in FIG. 1 in accordance with a representative embodiment. FIG. 3 is a perspective view of a keyboard 102 of the UI of the nozzle camera system 100 shown in FIG. 1 in accordance with a representative embodiment. FIG. 4 is a perspective view of the nozzle 110 of the nozzle camera system 100 shown in FIG. 1 in accordance with a representative embodiment. FIG. 5 is a perspective view of the nozzle 110 shown in FIG. 4 mounted on a flexible skid assembly 111 in accordance with a representative embodiment. FIG. 6 is a perspective view of the nozzle 110 shown in FIG. 4 mounted on a rigid skid assembly 112 in accordance with a representative embodiment. FIG. 7A is a back-end elevation view of the nozzle 110 shown in FIG. 4 in accordance with a representative embodiment. FIG. 7B is a top elevation view of the nozzle 110 shown in FIG. 4 in accordance with a representative embodiment. FIG. 7C is a cross-sectional view of the nozzle 110 shown in FIG. 4 taken along line A-A in FIG. 7B accordance with a representative embodiment. FIG. 7D is a side elevation view of the nozzle 110 shown in FIG. 4 in accordance with a representative embodiment. FIG. 7E is a cross-sectional view of the nozzle 110 shown in FIG. 4 taken along line B-B in FIG. 7D in accordance with a representative embodiment.

The nozzle 110 is a steerable nozzle with a built-in video camera that captures video images that are displayed on the display device 121 (FIG. 1) to provide exceptionally clear imagery and extreme maneuverability in virtually any size pipe. The display device 121 may be, for example, a bright 8″ LCD Display or any other suitable display device. In accordance with an embodiment, the system 100 includes a built-in battery with hours of runtime and a power cable 123 (FIG. 1) for corded operation or quick recharge of the battery. The liquid intake port of the nozzle 110 can be connected to, for example, connections of ¼″, ½″, and ¾″ hoses. The system 100 can include, for example, 200 feet of electrical cable 123 for electrically coupling the controller of the system 100 to the video camera. In accordance with an embodiment, the system 100 includes a built-in distance tracker that tracks the distance between the nozzle 110 and the UI at any given point in time.

The nozzle 110 is easy to navigate into and through laterals in a pipe system and has excellent pulling and cleaning power in pipes. In accordance with a representative embodiment, the jet former configuration of the nozzle 110 has five powerful rear thruster jet ports for propulsion, two forward jet ports for cleaning, and two control jet ports for steering. In accordance with a representative embodiment, the nozzle 110 is usable in pipes having diameters that are equal to or greater than two inches. In accordance with a representative embodiment, the system 100 is compatible with ¼″, ⅜″, ½″, ¾″ hoses (with appropriate adapter), although the system is not limited with respect to the size hoses that can be used. The system 100 can be run by the same hydro fetter, hydro cart, etc., that a cleaning team typically uses to clean a pipe. In accordance with an embodiment, the system 100 is configured to operate with a flow rate as low as five gallons per minute (GPM) and as high as eighty GPM, although the inventive principles and concepts are not limited with regard to the range of flow rates that it can accommodate.

The system 100 preferably provides CCTV playback—real time closed loop video of pipe inspection, allows video to be recorded to a memory card, e.g., an SDCard, and includes a built-in sun shield 122 (FIG. 1) for shielding the display device. The system 100 enables inspection and cleaning to be performed in the same session with a single crew, which reduces the number of trips that a crew has to take to the site. The system 100 can be compact in size and lite weight (e.g., 15.8″×13″×12.6″, 16 LBS).

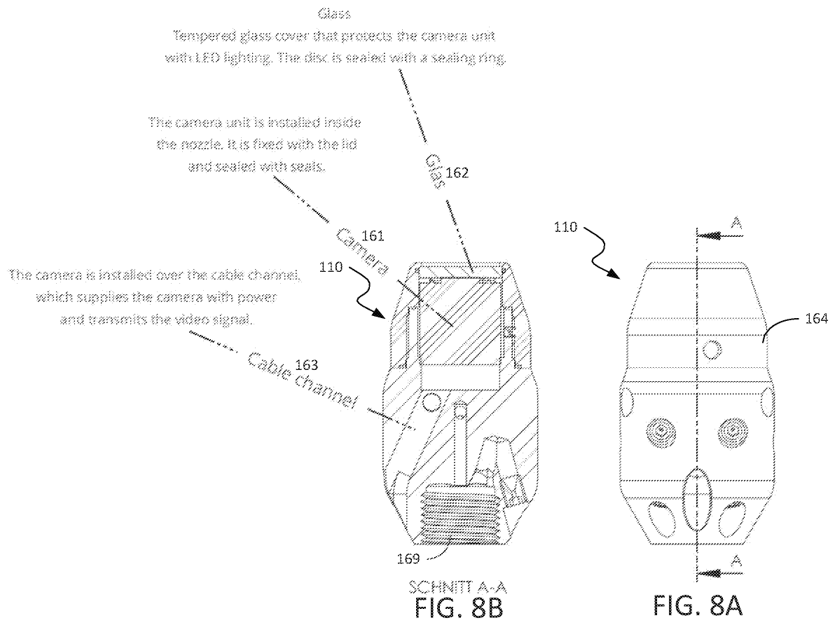

FIGS. 8A and 8B are the same views as shown in FIGS. 7B and 7C, respectively, but include identifiers for elements of the nozzle 110 in accordance with a representative embodiment to show their locations, such as the video camera 161, a transparent cover 162 that is within the field of view (FOV) of the camera 161 and a cable channel 163 through which the end of the electrical cable 123 is inserted into the main body 164 of the nozzle 110 for electrically coupling the controller of the system 100 with the camera 161. Preferably the electrical cable 123 includes electrical conductors for supplying electrical power to the camera 161 and for carrying video signals captured by the camera 161 to the controller for processing and display on the display device 121. FIG. 8B also shows the connection 169 of the liquid intake port for connecting the nozzle 110 to a fitting on the end of a hose.

With reference again to FIGS. 7B and 7D, the five rearward-facing thruster jet ports 166 and the two side-facing control jet ports 167 can be seen. In accordance with a representative embodiment, the ports 166 and 167 are configured to couple with ceramic inserts of different sizes that can be changed out to allow the sizes of the corresponding jets to be changed to accommodate different flow rates.

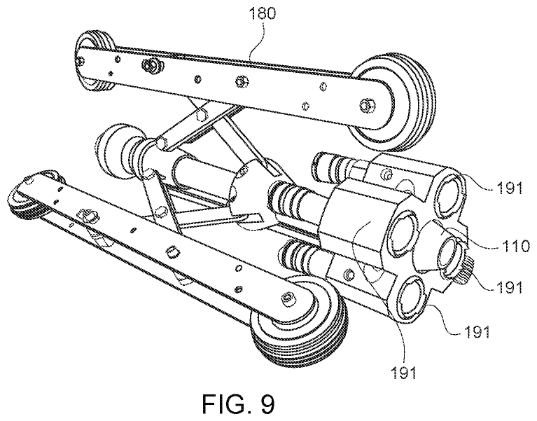

With reference again to FIG. 4, in accordance with a representative embodiment, a ring of light emitting diode (LED) lights 171 encircle the transparent cover 162. If more light is needed, a setup such as that shown in FIG. 9 may be used. FIG. 9 is a perspective view of the nozzle 110 mounted on a flexible skid assembly 180 and having a lighting adapter secured thereto that has four bright Led lamps 191 mounted in it.

The controller is typically mounted in the control panel 101 shown in FIG. 2 and is configured to perform one or more control algorithms. The control algorithms are typically, but not necessarily, implemented in software, firmware or a combination thereof stored on a memory device, which may be integrated with or separate from the controller.

In accordance with a representative embodiment, a sonde is located within the nozzle main body and transmits a preselected frequency or frequency range that can be detected by an electrical receiver and interpreted by the electrical receiver to determine at least one of a location of the nozzle 110, an orientation of the nozzle 110 and a direction of movement of the nozzle 110. The sonde may emit frequencies in the range of, for example, about 8 hertz (Hz) and about 512 Hz. The manner in which a sonde is used for such purposes is well known and therefore will not be further described herein in the interest of brevity.

With reference again to FIG. 3, the keyboard 102 can be built in or attached to the control panel 101. In some embodiments, the keyboard 102 is foldable toward the display 121 for stowage, in which case the sun shield 122 can be folded downward to protect both the keyboard 102 and the display 121. The user can enter commands via the keyboard 102 to control the operations of the system 100. As can be seen in FIG. 2, the control panel has a number of built in instrument controls for controlling the system 100, such as an on/off button 201, a knob 202 for adjusting the brightness of the illumination lamp(s) of the nozzle 110, a 12 volt power connection 203, a video out connection 204 and an indicator light 205 to indicate when the system 100 is being charged. The control panel 101 can contain a rechargeable battery to allow the system 100 to be used in the field.

With reference again to FIG. 1, in accordance with a representative embodiment, the system 100 includes a mount or support structure 211 to which various components of the system 100 are mechanically coupled. For example, a spool 212 for holding, organizing and feeding the cable 123 in and out can be mechanically coupled to the support structure 211. Likewise, the control panel 101 can be mechanically coupled to the support structure 211. Likewise, the display device 121 and sub shield 122 can be housed in a protective housing 214 that mechanically couples to the support structure 211. The support structure 211 can have any desired configuration and can be placed on a trailer for transport or be configured to be pulled by a vehicle to allow it to be moved from one location to another location.

It should be noted that the illustrative embodiments have been described with reference to a few embodiments for the purpose of demonstrating the principles and concepts of the invention. Persons of skill in the art will understand how the principles and concepts of the invention can be applied to other embodiments not explicitly described herein. For example, while particular configurations of the nozzle camera system 100 are described herein and shown in the figures, a variety of other configurations may be used, as will be understood by those skilled in the art in view of the description provided herein. Many modifications may be made to the embodiments described herein while still achieving the goals of the invention, and all such modifications are within the scope of the invention.

What is claimed is:

1. A nozzle camera system for inspecting an interior of a pipe, the nozzle camera system comprising:
a nozzle main body that serves as a housing for a camera and for a jet former configuration, the jet former configuration comprising at least one liquid intake port and at least one liquid flow channel, said at least one liquid intake port having a connection for connecting the jet former configuration to a liquid conduit that supplies liquid to the nozzle main body, said at least one liquid intake port being in fluid communication with said at least one liquid flow channel;
a video camera disposed in a front end of the nozzle main body in liquid isolation from the jet former configuration;
a transparent cover disposed in the front end of the nozzle main body within a field of view of the camera;
a controller in communication with the video camera and being configured to control operations of the nozzle camera system;
a user interface (UI) in communication with the controller, the UI including at least a display system in communication with the controller, the display system displaying video images captured by the video camera.

2. The nozzle camera system of claim 1, wherein the jet former configuration further comprises at least one control jet port and at least one thruster jet port, said at least one control jet port and said at least one thruster jet port extending from an exterior surface of the nozzle main body into the jet former configuration such that liquid supplied to the control and thruster jet ports from the liquid flow channel passes through the control and thruster ports out of the nozzle main body as liquid jets.

3. The nozzle camera system of claim 2, wherein the liquid jet passing out of said at least one thruster port impacts an interior surface of the pipe to create a force on the nozzle main body that thrusts the nozzle main body forward.

4. The nozzle camera system of claim 3, wherein the liquid jet passing out of said at least one control port impacts an interior surface of the pipe to create a force on the nozzle main body that moves the nozzle main body laterally.

5. The nozzle camera system of claim 1, further comprising:
an electrical cable, the electrical cable having a first end that is electrically coupled with the an electrical power source and a second end that passes through an electrical port formed in the nozzle main body, the electrical cable supplying power to the video camera and carrying video signals from the video camera to the controller.

6. The nozzle camera system of claim 5, wherein the UI further comprises:
a keyboard, wherein commands entered on the keyboard by a user are interpreted by the controller into operations to be performed by the nozzle camera system.

7. The nozzle camera system of claim 1, further comprising:
a liquid conduit having a first end that is connected to a liquid source and a second end that is connected to said at least one liquid intake port.

8. The nozzle camera system of claim 2, wherein a size of the control jet and thruster jet ports can be changed by changing out inserts that are removably coupled to the respective ports to accommodate different sizes of hoses that carry fluid at different flow rates.

9. The nozzle camera system of claim 8, wherein different size hoses can be connected to the connection of the liquid intake port by using different adapters.

10. The nozzle camera system of claim 6, further comprising:
a control panel that houses the controller, the control panel having a plurality of built in controls.

11. The nozzle camera system of claim 10, further comprising:
a support structure, the control panel being mechanically coupled to the support structure;
a spool mechanically coupled to the support structure, the electrical cable being held on the spool in a way that allows the electrical cable to be fed out and reeled in; and
a housing for housing the display system and the keyboard, the housing being mechanically coupled to the support structure and including a sun shield that is rotatably secured to the housing to allow the sun shield to be placed at various positions between an open position and a closed position for shielding the display system from sun light.

12. The nozzle camera system of claim 1, further comprising:
a receiver; and
a sonde located within the nozzle main body that transmits a preselected frequency or frequency range that can be detected by the receiver and interpreted by the controller to determine at least one of a location of the nozzle, an orientation of the nozzle and a direction of movement of the nozzle.

13. The nozzle camera system of claim 1, further comprising:
a light source for illuminating the interior of the pipe.

14. The nozzle camera system of claim 13, wherein the light source comprises a plurality of light elements that are mechanically coupled to the front end of the nozzle main body.

15. The nozzle camera system of claim 14, further comprising:
a rigid skid assembly, the nozzle being mounted on the rigid skid assembly.

16. The nozzle camera system of claim 13, further comprising:
a flexible skid assembly, the nozzle and the light source being mounted on the flexible skid assembly, wherein the light source comprises a plurality of lamps that are disposed a periphery of the nozzle main body.
